(19) United States
(12) Patent Application Publication
(10) Pub. No.: US 2022/0058319 A1
(43) Pub. Date: Feb. 24, 2022

(54) METHODOLOGY FOR ANALYSIS OF VALVE DYNAMIC CLOSURE PERFORMANCE

(71) Applicant: Expro North Sea Limited, Dyce, Aberdeenshire (GB)

(72) Inventors: Gordon Howat, Parton (GB); Phillip Agius, Kirkliston (GB); Rezana Zarshat, Aberdeen (GB); Simon Roberts, Aberdeen (GB)

(21) Appl. No.: 17/413,844

(22) PCT Filed: Dec. 6, 2019
(86) PCT No.: PCT/GB2019/053450

§ 371 Date: Jun. 14, 2021

(30) Foreign Application Priority Data
Dec. 13, 2018 (GB) 1820356.2

(51) Int. Cl. G06F 30/28; G06F 17/13

(52) U.S. Cl. CPC G06F 30/28; G06F 2119/02; G06F 17/13

(57) ABSTRACT

A method for calculating a valve closure time includes performing a computational fluid dynamics model simulation of the valve. The method also includes performing multiple functional performance analysis model simulations of the valve based on the computational fluid dynamics model simulation of the valve to calculate the valve closure time. The functional performance analysis model simulations are based on a numerical solution of a second order differential equation according to an equation of motion given by: (I), where m_{L} is a mass of translating components, y(t) is a piston displacement at a given time t, F_{τ} is a force on the valve due to fluid flow, Eμ is a friction force, F_{D} is a hydraulic damping force on the piston, F_{D} is a spring force, FPPA is a hydraulic piston pressure assist force, F_{BPA} is a hydraulic bore pressure assist force, and F_{G} is a force due to gravity.

This application claims priority to PCT Patent Appln. No. PCT/GB2019/053450 filed Dec. 6, 2019, which claims priority GB Patent Appln. No. 1820356.2 filed Dec. 13, 2018, which are herein incorporated by reference.

### BACKGROUND OF THE INVENTION

### 1. Technical Field

The present invention relates to the design, manufacture, and performance of valves and particularly the dynamic closure performance of safety valves required to meet stringent safety requirements.

### 2. Background Information

Safety valves designed to close to shut off fluid flow in the event of malfunction of an apparatus or process are known in the art. Examples include subsurface safety valves used in oil and gas lines to cut off the flow of oil and/or gas in the event of a malfunction. In this regard, a blowout preventer (BOP) is provided which is a specialized valve system used to seal, control, and monitor oil and gas wells to prevent the uncontrolled release of crude oil and/or natural gas from a well. A subsurface test tree (SSTT) is provided within the BOP system. The subsea test tree generally includes a valve system having one or more safety valves that can automatically close via a subsea safety shut-in system.

A specification for subsurface safety valve equipment is provided by the ANSI (American National Standards Institute)/API (American Petroleum Institute) specification 14A corresponding to ISO (International Organization for Standardization) 10432. The API 14A standard requires, among other things, that a subsurface safety valve should stop 95% of the flow-through, on command, within 5 seconds. A new standard, API 17G, is anticipated.

It is important to ensure that valves meet the performance requirements of the relevant standard. In principle, performance characteristic can be determined either by direct testing, via modelling analysis, or via a combination of these performance determining methodologies.

Conventional analysis of ball valve closure typically involves a computational fluid dynamics (CFD) model simulating the valve ball rotation and the fluid flow through the rotating ball. The simulation models closure in multiple small steps, simulating the fluid condition at each new position of the ball. At each new position the CFD model is interrogated, outputting the magnitude and direction of torque acting on the ball due to fluid flow over it. The CFD analysis thus provides a transient flow analysis capturing the dynamic closure of the valve. As the valve closes, the mesh is adapted to the new position as the time step specified. An adaptive mesh approach is used to give an optimum mesh resolution and thus get the most accurate results.

Such a model incorporates internally, or is coupled to externally, an additional calculation solving an equation of motion (EOM) for the valve mechanism, referred to as a functional performance analysis (FPA) model.

The FPA is also solved incrementally, in steps corresponding with those of the CFD model, and with the FPA calculation taking place after each CFD step. The FPA uses as inputs, the torque calculated by the CFD model at the current position, along with other input data not directly calculable by the CFD model.

The FPA model solves the equation of motion using the torque output by the CFD model at that position, and calculates the resulting acceleration, velocity and displacement of the valve mechanism. The displacement is then fed back to the CFD model, which rotates the ball an amount corresponding to that displacement. The process is then repeated, with a new CFD calculation generating a value of torque corresponding to the new position, and so on until valve closure, at which point closure time is calculated from the sum of the time to complete all increments. By using small enough steps, the method provides a good approximation of continuous motion.

This coupled approach, whereby data is passed back and forth between the CFD and FPA models at each incremental step is necessary where the fluid torque on the ball and the rotational velocity of the ball are mutually dependent and neither can be calculated in isolation.

S Leefe and C Williamson, “Presentation: Analysis of Closure Dynamics of Large Bore High Pressure Deepwater Gate Valves using CFD”, available from https://web.archive.Org/web/20180703174143/https://wildeanalysis.co.uk/resource/prese ntation-analysis-closure-dynamics-large-bore-highpressure-deepwater-gate-valves-using-cfd/ demonstrated the closure dynamics of large bore high pressure deepwater gate valves using Computational Fluid Dynamics (CFD).

### SUMMARY OF THE INVENTION

The present inventors have noted that the coupled approach described in the background section has a major short coming in that any change to the input data requires both the CFD model and the FPA model to be re-run. In comparison to FPA, the CFD model is time consuming and computationally expensive to run, typically having solution time measured in days, whereas the FPA model can be modified and re-run in minutes.

In light of the above, the present invention provides a methodology which de-couples the CFD model from the FPA model and permits a single CFD analysis to generate a value for the magnitude of the torque which can be used in as many FPA models as required. In this regard, it has been determined that for a given flow case, the torque on the ball due to bore fluid flow is effectively independent of the rate of closure of the ball. This finding permits decoupling of the CFD and FPA models. Using consistently conservative assumptions a single, worst case CFD analysis can be run and the calculated torque from that used in multiple subsequent FPA calculations. These FPA calculations can be used to quickly investigate the mechanism's response to variation of the other parameters which are not related to bore fluid flow but still have significant effect on closure time. The methodology as described herein thus enables valve designs to be more quickly modelled in order to assess functionality and, critically, whether the valve performance is such as to meet the requirements of the relevant standards. Changes to a valve design can thus be more quickly implemented and tested to arrive at a suitable valve design for a given application.

According to an aspect of the invention, there is provided a computer-implemented method for calculating a valve closure time, the computer-implemented method comprising: performing a computational fluid dynamics model simulation of the valve; and performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by:

[symbol]

ÿ(t)=F_{S}+F_{PPA}+F_{BPA}+F_{g}+F_{μ}+F_{D}+F_{τ}

where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity. The valve may be a ball valve comprising a ball and the computational fluid dynamics (CFD) model simulation of the valve calculates a magnitude and direction of torque acting on the ball due to fluid flow over the ball.

The computational fluid dynamics (CFD) model simulation of the valve can be performed for worst case boundary conditions (e.g. a maximum flow rate) of a system in which the valve is to be disposed in use.

The method may further comprise a determination of whether 100% of fluid flow through the valve is stopped within a predetermined time period (e.g. 10 seconds). Furthermore, the valve may form part of a subsurface test tree (SSTT). The valve may for instance be a ball valve, a flapper valve or a gate valve.

Test data at a first pressure and/or flow rate can be used as an input to model valve closure time at second pressure and/or flow rate, the first pressure and/or flow rate being lower than the second pressure and/or flow rate.

The computational fluid dynamics (CFD) model simulation of the valve may comprise:
(vi) building a 3D finite volume model of the valve;
(vii) discretising the finite volume model with unstructured cells which get finer in critical regions;
(viii) implement boundary conditions;
(ix) solving equations of conservation of mass and momentum; and
(x) post-processing results to extract a moment of forces due to pressure and viscosity and obtaining total moment of force on the valve.

Physical test data at zero flow rate can be used to extract friction forces and estimate the hydraulic damping coefficient used in the functional performance analysis (FPA) model simulations of the valve. The estimation of the hydraulic damping coefficient may comprise:
(iii) extracting the friction forces and closure times for zero and maximum pressure at a range of temperatures from test results; and
(iv) using an equation of motion to determine the hydraulic damping coefficient that would give an accurate closure time from the test results.

A force on the valve calculated using the computational fluid dynamics (CFD) model and a hydraulic damping force calculated using the functional performance analysis (FPA) model can be input to a further functional performance analysis (FPA) calculation to determine the valve closure time.

The hydraulic piston pressure assist force F_{PPA} and the hydraulic bore pressure assist force F_{BPA} can be set to a predetermined value (e.g., zero) since they assist closure of the valve.

Embodiments of the present invention can be provided in a variety of forms. For example, a computer readable storage medium can be provided which comprising computer-executable instructions which, when executed, configure one or more processors to perform the method as described herein. An electronic device can also be provided which comprises: an interface device; one or more processor(s) coupled to the interface device; and a memory coupled to the one or more processor(s), the memory having stored thereon computer executable instructions which, when executed, configure the one or more processor(s) to perform the method as described herein.

The computer implemented method can be used as part of a method for designing a valve. In this case, a method of designing a valve can be provided, the method comprising: designing a valve configuration; testing the valve configuration using the method as described herein in order to assess the valve's performance; modifying the valve configuration; and re-testing the modified valve configuration using the method as described herein in order to assess the modified valve's performance, wherein the method steps are re-iterated until a target valve closure time is achieved.

A computer-implemented method is disclosed for calculating a valve closure time, the computer-implemented method comprising: performing a computational fluid dynamics (CFD) model simulation of the valve; and performing multiple functional performance analysis (FPA) model simulations of the valve based on said computational fluid dynamics (CFD) model simulation of the valve to calculate the valve closure time.

### BRIEF DESCRIPTION OF THE DRAWINGS

Embodiments of the present invention are described by way of example only with reference to the accompanying drawings in which:

FIG. 1 shows a schematic of a computational fluid dynamics (CFD) analysis of a ball valve;

FIG. 2 shows a schematic of a hydraulic damping force analysis;

FIG. 3 shows a schematic of the FPA analysis to determine the valve closure time;

FIG. 4 shows an exemplary CFD model geometry;

FIG. 5 shows an exemplary CFD model boundary conditions;

FIG. 6 shows an exemplary plot of moment of force on a valve ball vs ball rotating angle illustrating that the effect of the ball angular velocity on moment force is negligible;

FIG. 7 shows a representation of piston displacement (m) (y-axis) vs ball valve closure time (s) (x-axis) for ball valve closure of a subsurface test tree (SSTT) −6,000 bbl/day, 10 ksi static pressure plot;

FIG. 8 8 shows a representation of piston displacement (m) (y-axis) vs ball valve closure time (s) (x-axis) for ball valve closure of a subsurface test tree (SSTT) −16,300 bbl/day, 10 ksi static pressure plot;

FIG. 9 shows a safe valve assembly which has been analysed;

FIG. 10 shows a simplified geometry of the safe valve assembly with a ball valve sitting in a cage in a closed position;

FIG. 11 shows a portion of the safe valve assembly showing the piston swept area;

FIG. 12 shows a model geometry used for CFD analyses;

FIG. 13 shows CFD model boundary conditions;

FIG. 14 shows streamlines of flow, which demonstrate that the streamlines are regular in the upstream and downstream parts of the geometry and more erratic in the inner part of the ball; and

FIGS. 15 to 20 show the piston displacement vs. ball valve closure time graphs.

### DETAILED DESCRIPTION OF THE INVENTION

The background to at least one example of the present invention resides in standard API 14A, in which 95% of the flow-through valve must be stopped, on command, within 5 seconds. A new standard, API 17G, is anticipated at the time of writing. Historically, verification of the closure time has been established using physical tests in combination with analysis. In reality, however, it is required to demonstrate that a valve meets the relevant standard in a worst case scenario, such as 10,000 PSI and maximum flow rate. It is difficult to physically test valve systems under such extreme conditions. As such, modelling is used to validate valve performance.

As described in the summary section, it has been determined that for a given flow case, the torque on the ball due to bore fluid flow is effectively independent of the rate of closure of the ball. This finding permits decoupling of the CFD and FPA models. Using consistently conservative assumptions, a single, worst case CFD analysis can be used and the calculated torque used in multiple subsequent FPA calculations. These FPA calculations can be used to quickly investigate the mechanism's response to variation of the other parameters which are not related to bore fluid flow but still have significant effect on closure time.

Embodiments of the invention can provide a determination of the closure time of a valve that takes into account a number of parameters, historical test data and CFD analysis. Embodiments can provide a faster and more efficient method of performing the analysis (using CFD data). Furthermore, embodiments can utilise a novel combination of CFD analysis and functional performance analysis.

The fluid forces on the ball are, for the cases examined to date, dominated by pressure, with forces due to viscous effects being secondary. The implication of this is that fluid properties are less important than boundary conditions, since boundary conditions limit the pressure drop which forms across the valve. This fact may be used to reduce the number of analyses or tests necessary for qualification.

In certain cases, the worst case scenario for valve closure is at maximum fluid flow. In other configurations, the worst case scenario for valve closure is no fluid flow. Since CFD requires some flow, a nominal minimum fluid flow can be utilized for the analysis in this case. For example, in the case of a 7300 SSTT (subsea test tree) valve, the torque on the ball due to bore fluid forces assists closure. This means the worst case scenario in terms of valve closure time is non-flowing, for which tests can be performed without the expense of a flow loop, pump and associated hardware. For those valves which flow assists closure, CFD may only be necessary to demonstrate that bore flow does indeed assist closure, after which neither CFD nor flow testing are required for conservative predictions of closure time.

So, whether the worst case scenario, i.e. the longest time for valve to close, is maximum flow or zero flow, the present methodology prescribes that a CFD calculation can be performed at the worst case scenario and then the calculated result used in multiple subsequent FPA calculations.

While certain embodiments relate to a ball valves ability to close under high pressure at specified flow rate, it should be noted that the principles of the present invention are not just applicable to ball valves and may also be applied to other types of valve comprising, for example, gates or flappers (although flappers may not close at very high pressure/flow rate).

The present invention removes the requirement to test at specific flow rates. Furthermore, the methodology can utilize test data at lower pressures (e.g., 2.5 kpsi) and/or flow rates and efficiently model valve performance to very high pressures (e.g., 10 kpsi) and/or flow rates. For example, a methodology can test at a set pressure (e.g., 5 kpsi) and then model valve performance to higher pressures.

Further details of the present invention are described below by way of example with particular focus on evaluation of compliance with API 17G 3rd Edition, Ballot Draft[1], (API 17G) here on referred to as API 17G.

### Dynamic Closure Methodology Evaluation

### Introduction

The dynamic closure analysis of a ball valve assembly is required to be undertaken as part of a qualification study to evaluate compliance with API 17G 3rd Edition, Ballot Draft, (API 17G) here on referred to as API 17G (API International, 2013, Specification for Subsea Well Intervention Systems, API 17G 3rd Edition, Ballot Draft, Washington: API).

It should be noted API 17G does not provide any specific guidance on how to perform the CFD study or functional performance analysis to assess the dynamic closure of a ball valve. There are no CFD studies of the ball valve combined with FPA examples in the literature.

### Methodology Process

A ball valve assembly system is modelled mathematically and the FPA is conducted based on the numerical solution of a second order differential equation referred here as the equation of motion:

[symbol]

ÿ(t)=F_{S}+F_{PPA}+F_{BPA}+F_{g}+F_{μ}+F_{D}+F_{τ} (2)

where [symbol] is the mass of the translating components and y(t) is the piston displacement at a given time t. The system is considered to be in forced motion due to the external forces acting on it, mainly:
8. Force on the ball due to fluid flow (F_{τ}).
9. Friction force (F_{μ}).
10. Hydraulic damping force on the piston (F_{D}).
11. Spring force (F_{S}).
12. Hydraulic piston pressure assist force (F_{PPA})
13. Hydraulic bore pressure assist force (F_{BPA}).
14. Force due to gravity (F_{g}).

The hydraulic piston pressure assist force and hydraulic bore pressure assist force may be considered as zero since they assist the closure of the valve.

### Stage 1: Determine Maximum Fluid Force on the Ball

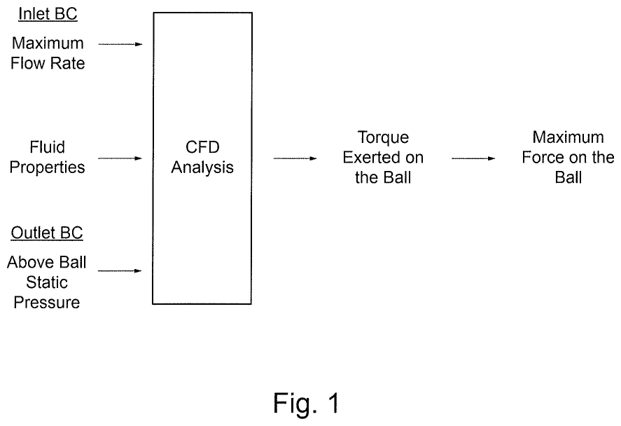

A CFD analysis is performed to quantify the external force exerted on the system by the fluid flow on the ball. FIG. 1 shows a schematic of the CFD analysis.

The process to determine the maximum force on the ball is as below:
f) Build a 3D finite volume model where the fluidic geometry is the hollow part of the valve assembly bounded by the ball valve surface and by the Seat Support Ring and Piston surface.
g) Discretise the finite volume model with unstructured cells which get finer in critical regions. A boundary layer mesh is also implemented in regions around the ball valve to ensure the fluid forces are adequately resolved in this region.
h) Implement boundary conditions where;
   a. A non-slip boundary condition is imposed on all solid surfaces wetted by the fluid.
   b. An appropriate boundary condition is selected to represent the velocity (e.g. a constant velocity is implemented at the inlet corresponding to the given volumetric flow rate).
   c. The turbulence at the inlet and outlet boundaries is specified via the turbulence intensity and hydraulic diameter.
   d. The outlet boundary is based on the above ball static pressure.
i) Solve the equations of the conservation of mass and momentum until:
   a. Domain mass imbalance is less than 1%.
   b. Pressure fluctuations between inlet and outlet boundaries are stable within 1%.
j) Post-process the results to extract the moment of the forces due to pressure and viscosity and obtain resulting total moment of force on the ball valve.

### Stage 2: Determine Hydraulic Damping Force

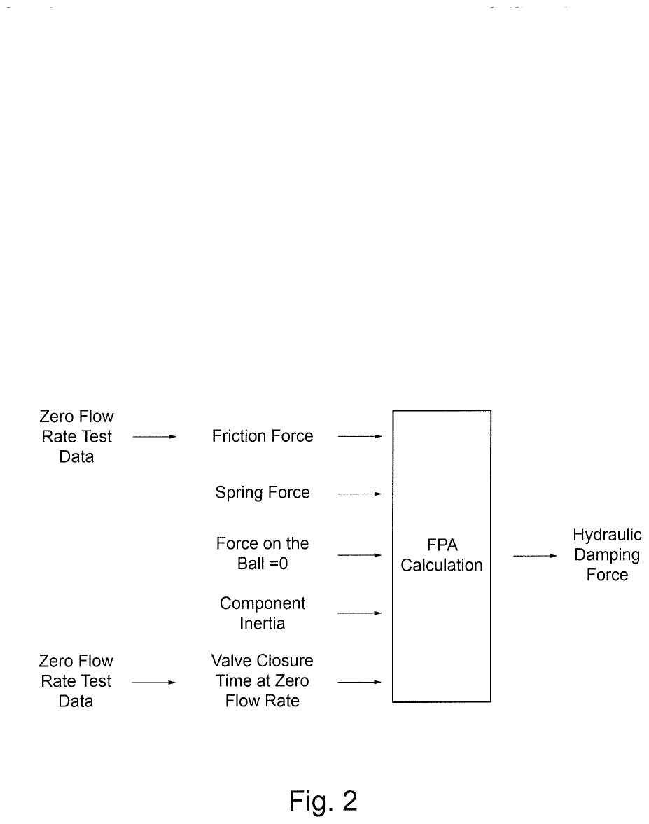

Physical test data at zero flow rate is used to extract friction forces and estimate the hydraulic damping coefficient used in the FPA. FIG. 2 shows a schematic of the hydraulic damping force analysis.

The process to estimate the hydraulic damping force is as below:
c) Extract the friction forces and the closure times for zero and maximum pressure at a range of temperatures from the test results.
d) Use the equation of motion (1) to determine a hydraulic damping coefficient that would give an accurate closure time from the test results. In this case, neglecting the assist forces, Equation (1) would reduce to:

[symbol]

ÿ(t)−F_{S}−F_{g}−F_{μ}=F_{D} (2)

### Stage 3: Determine Valve Closure Time

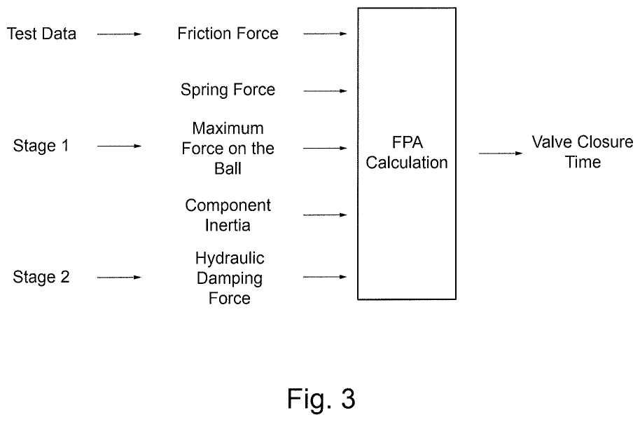

After the unknown values in the FPA are estimated from Stage 1 and Stage 2, the dynamic closure time is estimated using the FPA based on the equation of motion given in Equation (1). FIG. 3 shows a schematic of the FPA analysis to determine the valve closure time.

The methodology has been used, for example, to calculate the dynamic closure of a 7.375 inch (18.73 cm), 10 ksi (70 MPa) safety valve.

### Worked Examples

### Dynamic Closure Methodology Evaluation

In this example, the results of a computational fluid dynamics (CFD) and functional performance analysis (FPA) for a 7300 10 ksi Subsea Test Tree (SSTT) assembly are provided. The dynamic closure analysis of the ball valve assembly has been undertaken as part of a qualification study to evaluate the SSTT's compliance with API 17G 3^{rd} Edition, Ballot Draft, (API 17G). The closure time analysis results are compared with a dynamic closure test.

The SSTT dynamic closure evaluation analysis has been performed to assess the ball valve closure time of the ball valve under the following conditions:
Test rate no. 1: 10 ksi pressure, liquid, dynamic at 6,000 bbl/day flow rate.
Test rate no. 3: 10 ksi pressure, liquid, dynamic at 16,300 bbl/day flowing rate.

It may be noted that a 1 bbl/day (1 barrel oil per day) unit of flow rate is equivalent to 0.0066 m³/h (cubic meter per hour).

The CFD analysis quantifies the fluid force on the ball valve. The moment of the fluid force is used in the FPA with other external forces as an input for the solution of the mechanism's equation of motion (EOM) to then quantify the closure time.

The software used for the CFD analysis is ANSYS Fluent version 17.1 and the software used for the FPA is Mathcad version 15.

### CFD Analysis

### Flow Conditions

CFD analyses were performed to determine the effect, magnitude and direction of the moment of force on the ball while closing under the conditions stated in the table below. It should be noted that for the CFD analyses, both gas and liquid can be considered as incompressible flows for flow rates up to 16,300 bbl/day as the Mach number would be less than 0.3. As the flow can be considered incompressible, the effects due to changes in density would be minimal for liquid and gas.

| ID | Flow Case Details |
|---|---|
| TAT-022 | Minimum flow rate (6,000 BPD), angular |
| | velocity sensitivity &.damping coefficient for FPA |
| | (ω = 0.393 rad/s), transient flow analysis. |
| TAT-023 | Minimum flow rate (6,000 BPD), angular |
| | velocity sensitivity &.damping coefficient for FPA |
| | (ω = 0.079 rad/s), transient flow analysis. |
| TAT-050 | Maximum flow rate (16,300 BPD), constant angular |
| | velocity (ω = 0.079 rad/s), evaluation |
| | case transient flow analysis. |

### CFD Model Geometry

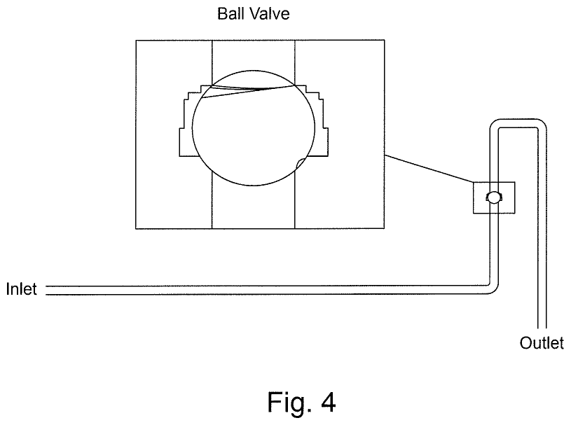

The model geometry used for CFD analyses was simplified and de-featured from the design drawings and is shown below in FIG. 4. The ball valve in the model was allowed to rotate with constant angular velocities as shown in the table. It should be noted that for a ball rotated more than 85° the valve is considered closed to a point that it prevents the flow continuity above the ball valve. Therefore the valve for this CFD analysis was rotated up to 81.2°.

### CFD Model Mesh

A mesh sensitivity study was performed. From the sensitivity study it was recommended that the unstructured mesh should have a maximum element size of 0.015 m to minimize the pressure difference at the inlet boundary. A boundary layer mesh was created on the internal surfaces of the main fluid conduit, to ensure fluid forces on the ball were adequately resolved. To achieve Y⁺=1 a first layer thickness of y¹=0.000027 m was applied. The resulting mesh has approximately 5.5 million elements.

For the evaluation case, a solution adaptive mesh was used. Due to the ball rotating with an angular velocity of 0.079 rad/s, the mesh was manually adapted to the solution at approximately every 5 time steps in order to keep the maximum resolution at critical regions.

### CFD Boundary Conditions

For the ball valve angular velocity sensitivity study, an inlet velocity of 0.4 m/s corresponding to the minimum flow rate (6000 bbl/day), was selected. For the evaluation case an inlet velocity of 1.09 m/s corresponding to maximum flow rate (16300 bbl/day) was used. The table below shows the flow rates and the corresponding inlet velocities for the valve bore cross sectional area of 0.028 m² (valve bore diameter 0.187 m).

| | | Valve Bore | |
|---|---|---|---|
| | | Cross Sectional | Inlet |
| Flow Rate | | Diameter | Velocity |
| bbl/day | m³/s | m | m/s |
| 6000 | 0.011 | 0.187 | 0.400 |
| 16300 | 0.030 | 0.187 | 1.090 |

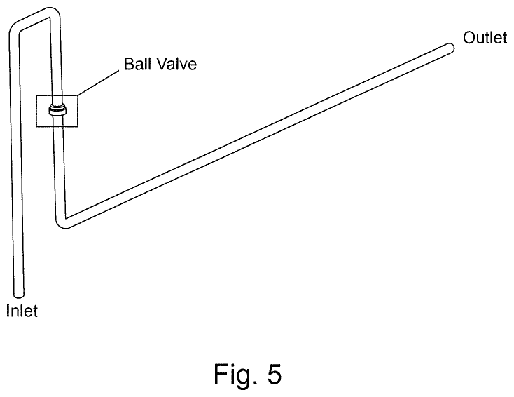

The ball valve, upstream and downstream pipes were specified as wall boundaries to account for the non-slip condition and the outlet was specified as a pressure outlet with a static pressure set to zero. The boundaries of the model are illustrated in FIG. 5.

### CFD Analysis Results

### Ball Valve Angular Velocity Sensitivity

A CFD sensitivity study was performed to assess the effect of the angular velocity of the rotating ball valve on the moment of force. The analysis was run with the ball rotating at minimum flow rate, 6,000 bbl/day (Flow test no. 1) with two different angular velocities; 0.393 rad/s and 0.079 rad/s. An angular velocity of 0.393 rad/s was based on the assumption that the ball valve is closing for 4 s and an angular velocity 0.079 rad/s is based on the assumption that the valve is closing for 20 s. The ball valve was initially rotated at a position of 30° towards closure. This was so to avoid the distortion of the dynamic mesh toward the end of the solution leading to divergence.

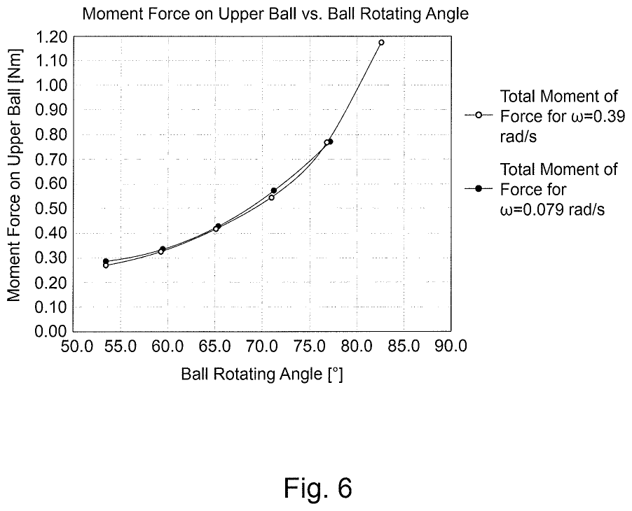

The results of the sensitivity study as shown in FIG. 6 show that the effect of the ball angular velocity on moment force is negligible. Therefore the angular velocity is not expected to be a factor in the FPA analysis. This can be related to the decoupling nature of the analysis. From FIG. 6 it can also be observed that for a flow rate of 6,000 bbl/day the moment force on the ball is minimal. The moment force calculated from the sensitivity study analysis TAT-023 is used in the FPA analysis to calculate the damping coefficient that will be used in the FPA for the evaluation case.

### CFD Evaluation Case Results

The analysis evaluation load case replicates specifically, the dynamic closure test performed on an upper ball during an API 14A SCSSV Class 1 Flow Tests at test flow rate three, as per step 7.5.14 of API 14A. The average closure time of the five repeat tests was 12.4 s.

A transient flow simulation was run with the ball rotating at an angular velocity of 0.079 rad/s toward valve closure. The solver was paused at 10 time steps initially and 5 time steps toward the ball valve closure as described in Section 2.3 of this document. The results were tabulated in Table 3 for every 50 time steps. From the results it was observed that the dynamic pressure of the flow exerted positive moment of forces on the ball, which would assist the closure of the valve. In the table below it can also be observed that the moment of forces on the ball valve resulting from the viscous forces are relatively small compared to those from pressure forces.

| | | | | | Moment^{a} | | | Moment^{b} |
|---|---|---|---|---|---|---|---|---|
| | Time | Flow | Ball Valve | Ball | (Half Model) | | | (Full Model) |
| CFD Results^{[9]} | step | Time | Velocity | Angle | Pressure | Viscous | Total | Total |
| Filename | [-] | [s] | [rad/s] | [°] | [Nm] | [Nm] | [Nm] | [Nm] |
| TAT-050-1-00010.dat | 10 | 0.5 | 0.079 | 2.3 | −0.07 | 0.00 | −0.04 | −0.07 |
| TAT-050-1-00050.dat | 50 | 2.5 | 0.079 | 11.3 | 0.22 | 0.00 | 0.22 | 0.43 |
| TAT-050-1-00100.dat | 100 | 5.0 | 0.079 | 22.6 | 0.53 | 0.01 | 0.54 | 1.08 |
| TAT-050-1-00150.dat | 150 | 7.5 | 0.079 | 33.9 | 0.84 | 0.01 | 0.85 | 1.70 |
| TAT-050-1-00200.dat | 200 | 10.0 | 0.079 | 45.3 | 1.19 | 0.02 | 1.21 | 2.41 |
| TAT-050-1-00250.dat | 250 | 12.5 | 0.079 | 56.6 | 1.15 | 0.02 | 1.17 | 2.33 |
| TAT-050-1-00300.dat | 300 | 13.5 | 0.079 | 61.2 | 1.85 | 0.01 | 1.86 | 3.72 |
| TAT-050-1-00350.dat | 350 | 14.0 | 0.079 | 63.4 | 2.05 | 0.00 | 2.05 | 4.10 |
| TAT-050-1-00400.dat | 400 | 14.4 | 0.079 | 65.2 | 2.67 | 0.03 | 2.70 | 5.39 |
| TAT-050-1-00450.dat | 450 | 15.1 | 0.079 | 68 5 | 3.32 | 0.02 | 3.34 | 6.69 |
| TAT-050-1-00500.dat | 500 | 16.3 | 0.079 | 73.8 | 7.74 | 0.06 | 7.80 | 15.60 |
| TAT-050-1-00550.dat | 550 | 17.0 | 0.079 | 77.2 | 14.65 | 0.17 | 14.83 | 29.65 |
| TAT-050-1-00600.dat | 600 | 17.7 | 0.079 | 80.3 | 46.54 | 0.42 | 45.96 | 93.92 |
| TAT-050-1-00640.dat | 640 | 17.9 | 0.079 | 81.2 | 86.75 | 0.72 | 87.47 | 174.94 |

^{a}Moment from forces on the bat (half symmetry)
^{b}Moment from forces of the ball, increased by a factor of 2.0 to account for the whole model.

For the evaluation case a moment force of 174.94 Nm for ball valve rotated at maximum closure (ball valve rotated at 81.2°) was selected as a conservative value of the dynamic fluid force input for the FPA calculations.

For the minimum flow case a moment force of 1.179 Nm at maximum closure (ball valve rotated at 81.2°) was selected for the dynamic fluid force input for the FPA calculations to calibrate the hydraulic damping.

### Functional Performance Analysis Results

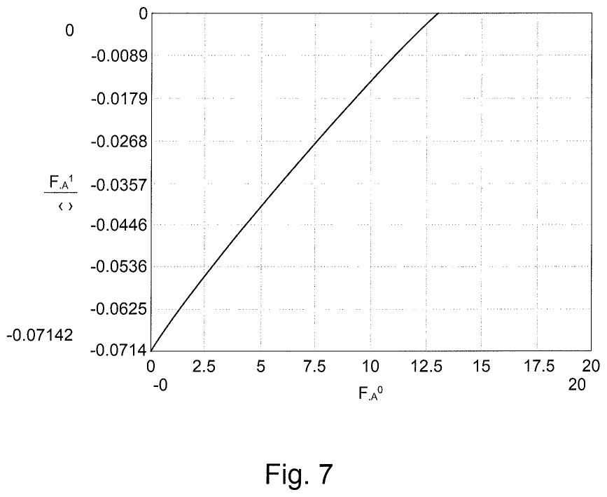

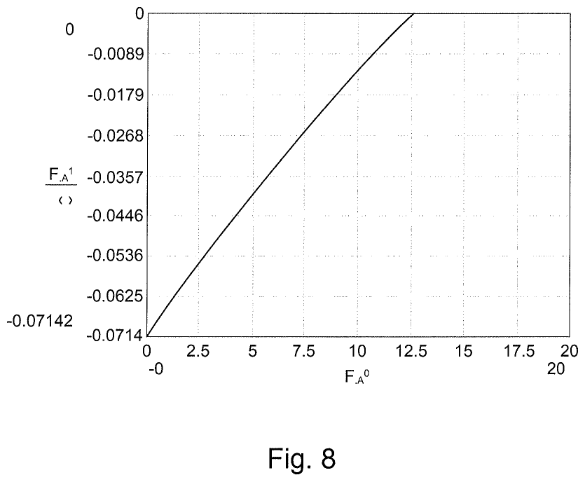

The hydraulic damping and the static friction coefficients in the equation of motion (EOM) for the FPA calculations have been estimated from test data. The FPA results were evaluated by creating and solving the EOM for the ball valve mechanism and deriving the main forces on the piston component. The FPA results are detailed in the table below and the piston displacement vs. ball valve closure time graphs are shown in FIGS. 7 and 8. These Figures provide a representation of the piston displacement (m) (y-axis) vs ball valve closure time (s) (x-axis) for the ball valve closure of the SSTT. FIG. 7 shows a representation of piston displacement (m) (y-axis) vs ball valve closure time (s) (x-axis) for ball valve closure of a subsurface test tree (SSTT) −6,000 bbl/day, 10 ksi static pressure plot. FIG. 8 shows a representation of piston displacement (m) (y-axis) vs ball valve closure time (s) (x-axis) for ball valve closure of a subsurface test tree (SSTT) −16,300 bbl/day, 10 ksi static pressure plot.

| Flow | Flow | Static | | Time to |
|---|---|---|---|---|
| Case | Rate | Pressure | Temperature | close |
| ID | [bbl/day] | [ksi] | [° C.] | [s] |
| 1 | 6,000 | 10 | Ambient | 13.000* |
| 2 | 16,300 | 10 | Ambient | 12.548 |

*This time was an input to the FPA calculation and is the average of the five repeat tests carried at this flow rate. This FPA calculation allows evaluation of the hydraulic damping coefficient which is then used in the higher flow case FPA.

### Discussion of Results

The results of the velocity sensitivity study show that the effect of the ball angular velocity on moment force is negligible. This demonstrates the fluid velocities involved are orders of magnitude greater than the range of ball surface velocities.

The moment of forces induced on the ball while rotating up to 81.2° are calculated in the CFD analyses. It is notable that the moment's direction is shown to aid the valve closure. The size and direction of the fluid induced moment on the ball valve mechanism is shown over the closing ball angle range for the maximum flow rate, 16,300 bbl/day. The maximum moment of 174.94 Nm is used in the FPA calculation. This compares to a peak moment of 1.18 Nm developed in the minimum flow rate, 6,000 bbl/day, CFD analysis. Both these values are orders of magnitude smaller than other moments acting on the ball. Typically the moments induced by the spring and hydraulic damping are 30 to 100 times greater than the fluid forces. Thus the fluid forces only have a marginal effect on the time to closure and that is to reduce it. Consequently the estimate for the maximum flow rate test gives a shorter closure time compared to the closure time for the minimum flow rate case.

The CFD analysis and FPA calculation matches the order of magnitude and sense of change in the closure time between the two flow rate cases. In the test results the closure time for flow rates ranging from 15750 bbl/day to 16300 bbl/day varies from 12.0 s to 14.0 s. From the analysis the closure time for a flow rate 16300 bbl/day is estimated to be 12.5 s which is found to be comparable with the test results, which had an average closure time of 12.4 s.

### Conclusions

The dominant forces were found to be the spring force and the hydraulic damping and these were found up to 100 times greater than the moment of fluid force.

The moment of force from the CFD for the flowing cases was found to assist the closure time, however it was a relatively small improvement over the respective non-flowing cases.

The dynamic closure time for the maximum flow case (16,300 bbl/day) was 12.5 s, which shows good comparison with the average test closure time of 12.4 s.

From the analysis results presented in this report, it can be concluded that the dynamic closure methodology is suitable for calculating the closure time for such valve assemblies.

### Safe Valve Dynamic Closure Analysis

A basis for performing dynamic closure analysis of a safe valve (7.375 IN, 10 KSI) assembly is described. The analysis is undertaken as part of a qualification study to evaluate the safe valve's compliance with API 17G 3^{rd} Edition, Ballot Draft, (API 17G). The analysis uses the methodology for analyzing ball valve dynamic closure performance as described herein. The methodology adopts computational fluid dynamics (CFD) and functional performance analysis (FPA) to assess the ball valve closure performance. The objective of the analyses is to predict the closure time of the safe valve under specific operating conditions as detailed in the following text.

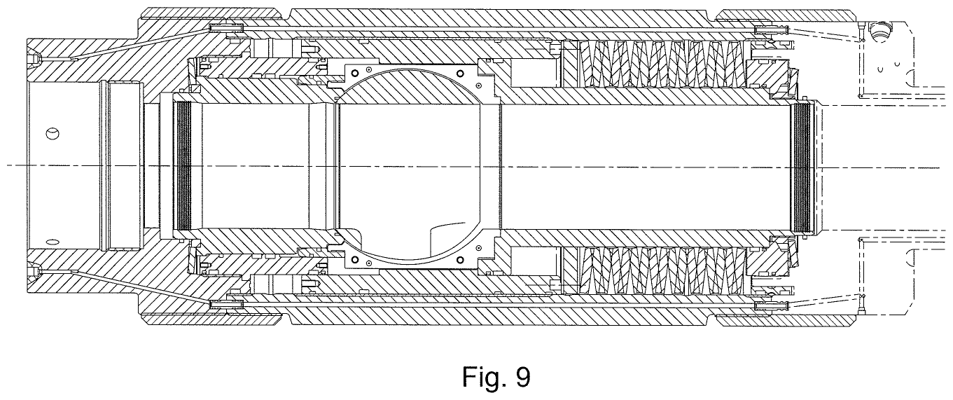

The safe valve assembly being analyzed is shown in FIG. 9. The CFD model shall simulate the flow of fluid through the valve bore during closure of the valve ball. The moment of forces exerted on the ball by the bore fluid shall be extracted from that simulation for subsequent use in functional performance analysis (FPA).

The FPA scope shall include:
Upper limit of damping force due to pressure loss within the open and close hydraulic control circuits.
Friction within the mechanism.
Bore fluid pressure & viscous forces on the ball.
Component inertia.
Actuator spring force.

### Computational Fluid Dynamics Analysis

An initial CFD analysis shall be performed to determine the magnitude and direction of the maximum torque on the ball due to bore fluid forces while closing under the conditions listed in the table below.

| | | Maximum | Minimum | |
|---|---|---|---|---|
| | | Below-Ball | Above-Ball | Maximum |
| | Fluid | Pressure | Pressure | Flow Rate |
| Software | Type | [MPa(kpsi)] | [MPa(kpsi)] | [bbl/day] |
| Fluent | Liquid | 0(0) | 0(0) | 14,000 |

From recent field experience and maximum flow rates seen on liquid and gas jobs, a value of 14,000 bbl/day from crude oil type jobs is selected as the highest flow rate to use. It should be noted that for the CFD analysis, both gas and liquid can be considered as incompressible flows for flow rates up to 14,000 bbl/day as the Mach number would be less than 0.3. As the flow can be considered incompressible, the changes in density would be minimal for liquid and gas. The calculated torque shall be used in a subsequent FPA.

### Geometry Assumptions and Simplifications

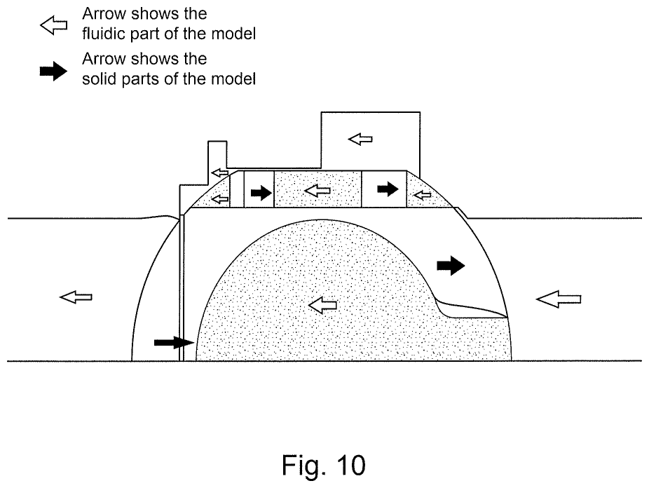

The geometry used for CFD analyses can be simplified and/or de-featured. A sample of a simplified geometry is shown in FIG. 10. The ball valve in the model is rotated at 80 degrees from closure to capture the maximum bore fluid forces. It should be noted that the ball is rotated to 80 degrees from closure to create a feasible CFD model. A ball rotated more than 85 degrees would mean the valve is closed to a point that it prevents the flow continuity above the ball valve and for a rotation less than 80 degrees the resulting fluid forces can be considered less than those at 80 degrees.

### Computational Mesh

The mesh used for the CFD analysis is as previously described.

### Boundary Conditions

### Inlet Boundary Condition

The model shall be run with an appropriate boundary condition to represent the velocity and volumetric flow rate (e.g., a velocity inlet boundary condition and volumetric flow rate as previously indicated). The CFD model inlet boundary location and turbulence boundary conditions are calculated.

### Outlet Boundary Condition

The model shall be run with 0 psi static pressure-outlet boundary condition. The CFD model outlet boundary location shall be located 60 bore diameters downstream of the safe valve to capture a fully developed flow. The outlet turbulence boundary condition shall be specified as per the method described herein.

### Finite Volume Model

### Analysis Software

The analysis shall use the software ANSYS Fluent version 17.1.

### Bore Fluid Properties

The bore fluid is advised as Brent Crude, the properties of which are listed in the table below.

| | | | Dynamic |
|---|---|---|---|
| | Temperature | Density | Viscosity |
| Liquid | [° C.] | [kg/m3] | [kg/m · s] |
| Brent Crude | 50 | 1000 | 0.002488 |

### Post Processing

The CFD analysis case is post processed, extracting the torque exerted on the ball by the bore fluid for use in FPA.

### Functional Performance Analysis

### Analysis Tasks

The functional performance analysis refers to the creating and solving of the equation of motion (EOM) for the mechanism and requires a derivation of the main forces on the piston component. It should be noted that for this valve the FPA does not consider bore pressure assist since the safe valve does not have this functionality.

FPA tasks are listed in the table below and detailed further in the following sections.

Flow Case Details
Operational case-maximum flow rate, 10 ksi static pressure.
Operational case-zero flow rate, 0 ksi and 10 ksi static pressure.

### Assumptions and Simplifications

General assumptions and simplifications relating to the FPA are as previously described. Further assumptions and simplifications are:
The spring pack mass is treated as a solid body and added to the mass of the piston in the equation of motion (EOM) and is a conservative simplification as it increases the inertia calculated for the mechanism.
The Ball Rotation Boot inertia is accounted for by calculating a combined moment of inertia for both the Boots and Ball. The combined moment of inertia will be calculated with the Ball Rotation Boots at their maximum radial position, maximising the rotating assembly's moment of inertia as a conservative simplification.

### Initial Conditions

At the start of solution of the EOM, initial conditions shall be specified such that the mechanism is displaced by an amount equal to the piston stroke such that the Piston and Ball would be in the fully open position. Initial velocity is specified as zero.

### Equation of Motion Solver

The EOM shall be solved numerically for instantaneous acceleration and integrated with respect to time to determine velocity and displacement. The numerical solver will be based on the 4th order Runge-Kutta adaptive step method and the EOM shall be solved over a time period adequate to permit full closure of the mechanism. The FPA can use the software PTC MathCAD, Version 15.

### Functional Performance Analysis Parameters

### Hydraulic Control Fluid Displaced Volumes

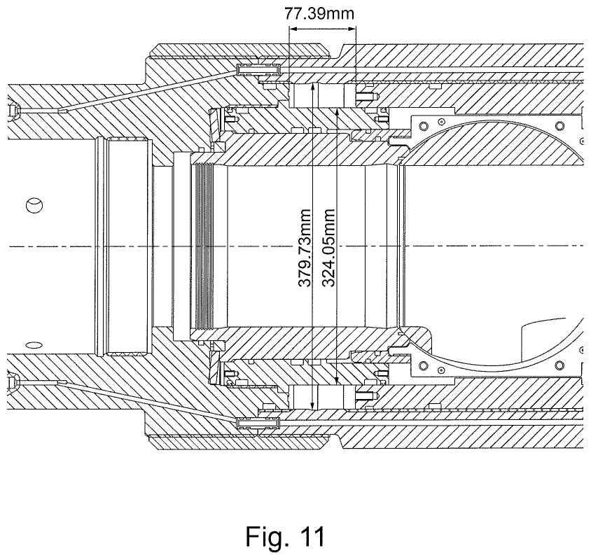

Actuation of the mechanism toward the closed position causes displacement of hydraulic control fluids which results in an accompanying hydraulic damping force due to pressure loss in the displaced fluid. With no bore pressure assist function on the safe valve, the open and close volumes swept by the Piston are identical. The dimensions of the volume displaced by piston motion are detailed in FIG. 11 adjacent to the area highlighted. On the open side of the piston, the cylinder volume decreases with closure, displacing hydraulic fluid out of the cylinder into the control line. Dimensions for the areas swept by the piston and the spring pusher are provided in the table below.

| Dimension | Nomenclature | Value | Units |
|---|---|---|---|
| Piston ID | SOID | 324.05 | [mm] |
| Piston OD | SOOD | 379.73 | [mm] |
| Swept Area | SOA | 2.435e−3 | [m²] |
| Piston Stroke | Py | 76 | [mm] |
| Displaced Piston | PV | 1.88e−4 | [m³] |
| Volume | | | |

### Spring Constant and Pre-Compression Displacement

The spring constant k and the spring pre-load displacement for the spring pack are provided in the table below. These values shall be used in the FPA to calculate spring force on the mechanism.

| Parameter | Value | Units |
|---|---|---|
| Spring constant | 1,587,011 | [N/m] |
| Spring pre-compression | 0.059831 | [m] |

### Component Inertia

The component mass and inertia during dynamic closure are given in the tables below. In addition the radial offset of the boot hole in the piston is provided below, which is used for calculating the moment of inertia of the rotating components.

| | Mass |
|---|---|
| Component | [kg] |
| PRODUCTION PISTON | 98 |
| SPRING PUSHER | 7 |
| DISC SPRING | 6.7 |

| | Moment |
|---|---|
| | of Inertia |
| Component | [kg · m2] |
| Cutting Ball | 0.342 |
| Ball Rotation Boot | |

| | Radial |
|---|---|
| | Offset |
| Component | [m] |
| Production Piston | 0.0381 |

### Friction Forces

Test data is used to define the friction forces for 0 and 10 ksi bore pressures at 0° C. and 121° C. temperatures and is shown in the table below.

| | | Friction |
|---|---|---|
| Temperature | Pressure | Force |
| [° C.] | [ksi] | [N] |
| 0 | 0 | 59,771 |
| 121 | 0 | 44,051 |
| 0 | 10 | 75,473 |
| 121 | 10 | 48,930 |

Linear interpolation of the friction force data is to be used in the FPA calculations for these specific temperature and pressure conditions.

### Valve Closure Time

Test data has been provided that defines the valve closure times at 0 and 10 ksi bore pressure at ambient temperature (15° C.). These timings were observed by monitoring the hydraulic fluid draining from open lines. Closure times from testing are set out below.

| | | Closure |
|---|---|---|
| Temperature | Pressure | Time |
| [° C.] | [ksi] | [s] |
| 15 | 0 | 10.0 |
| 15 | 10 | 11.0 |

The above times will allow an estimate of the hydraulic damping forces for these configurations of the valve test set up assembly. These forces are obtained by solving the EOM iteratively to give the correct closure time by adjusting the hydraulic damping force to suit. [0102] Specifically the correct hydraulic damping force will yield the desired closure time.

These hydraulic damping force estimates can be conservatively used for the higher temperature cases of the flowing FPA's. This is because they will be overestimates as the viscosity and damping of the hydraulic fluid is greater at lower temperatures.

### Safe Valve Dynamic Closure Analysis

In this section, the results of the computational fluid dynamics (CFD) and functional performance analysis (FPA) of the 7.375 in 10 ksi safe valve are provided. This analysis project was performed to evaluate the dynamic closure of the safe valve. Previous sections have detailed the analysis approach, methodology and modelling assumptions. The safe valve dynamic closure analysis has been performed to assess the ball valve closure time of the safe valve under the following conditions:
Operational case: Flowing, 10 ksi pressure, liquid, dynamic at 15° C. and 50° C.
Operational case: Zero flow 0 ksi & 10 ksi pressure, static at 15° C. and 50° C.

The CFD analysis quantifies the forces on the ball valve and the FPA uses the moment of fluid forces on the ball valve with other external forces, as an input for the solution of the mechanism's equation of motion, to quantify closure time. The software used for the CFD analysis is Fluent, version 17.1 and Mathcad, version 15 for the FPA analysis.

### CFD Analysis

### Flow Conditions

A CFD analysis was performed to determine the magnitude and direction of the moment of force on the ball while closing under the conditions stated in the table below.

| | Bore Static | Maximum |
|---|---|---|
| | Pressure | Flow Rate |
| Fluid Type | [MPa(kpsi)] | [bbl/day] |
| Liquid | 0(0) | 14,000 |
| (Brent Oil) | | |

From recent field experience and maximum flow rates seen on liquid and gas jobs, a value of 14,000 bbl/day from crude oil type jobs was selected as the highest flow rate to use.

It should be noted that for the CFD analysis, both gas and liquid can be considered as incompressible flows for flow rates up to 14,000 bbl/day as the Mach number would be less than 0.3. As the flow can be considered incompressible, the changes in density would be minimal for liquid and gas.

### CFD Model Geometry

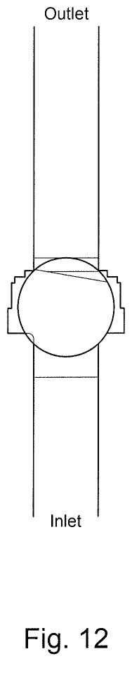

The model geometry used for CFD analyses was simplified and de-featured from the design drawings and is shown below in FIG. 12.

The ball valve in the model was rotated 80 degrees from closure to capture the maximum bore fluid forces. It should be noted that the ball is rotated to 80 degrees from closure to create a feasible CFD model. A ball rotated more than 85 degrees would mean the valve is closed to a point that it prevents the flow continuity above the ball valve and for a rotation less than 80 degrees the resulting fluid forces can be considered less than those at 80 degrees.

### CFD Model Mesh

A mesh sensitivity study was performed. From the sensitivity study it is recommended that the mesh should be unstructured with a maximum element size of 0.015 m to minimize the pressure difference at the inlet boundary. For the SV model an unstructured mesh with a maximum element size of 0.008 m is used in the CFD model. A boundary layer mesh was created on the internal surfaces of the main fluid conduit, to ensure fluid forces on the ball were adequately resolved. To achieve y⁺=1 a first layer thickness of y¹=0.000054 m was applied. The resulting mesh has approximately 4.5 million elements.

### CFD Boundary Conditions

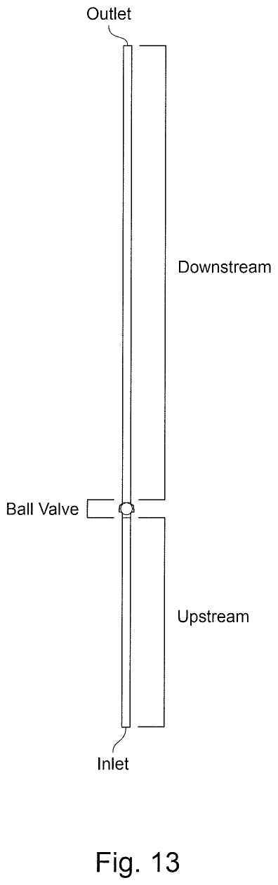

The inlet was specified with a velocity of 0.935 m/s that corresponded to the flow rate previously specified. The ball valve, upstream and downstream pipes were specified as wall boundaries to account for the non-slip condition and the outlet was specified as a pressure outlet with a static pressure set to zero. The boundaries of the model are illustrated in FIG. 13.

### CFD Results

A steady state simulation was run with the ball rotated at an angle of 80 degrees to closure and at 50° C. 10,000 iterations were set initially and data files were saved every 500th iteration step. The solution was observed to reach convergence at approximately 5,000 iterations. Moment of the forces due to pressure, viscosity and the resulting total moment of forces were post processed for up to 7,000 iterations provided in the table below.

| | | | | | Moment of the |
|---|---|---|---|---|---|
| | | | | | forces on Ball |
| | | | | | (factored by 2.0 |
| | | Moment from the forces on Ball | | | to account for |
| | Flow | (half model, due to symmetry) | | | the whole model) |
| CFD result filename at every | Velocity | Pressure | Viscous | Total | Total |
| 500 iteration | [m/s] | [Nm] | [Nm] | [Nm] | [Nm] |
| TAT001_ATO_4891_00500.dat | 0.93 | 25.25 | 0.30 | 25.55 | 51.11 |
| TAT001_ATO_4891_01000.dat | 0.93 | 25.23 | 0.28 | 25.52 | 51.03 |
| TAT001_ATO_4891_01500.dat | 0.93 | 25.24 | 0.28 | 25.52 | 51.04 |
| TAT001_ATO_4891_02000.dat | 0.93 | 25.25 | 0.28 | 25.53 | 51.06 |
| TAT001_ATO_4891_02500.dat | 0.93 | 25.23 | 0.28 | 25.51 | 51.02 |
| TAT001_ATO_4891_03000.dat | 0.93 | 25.21 | 0.28 | 25.49 | 50.99 |
| TAT001_ATO_4891_03500.dat | 0.93 | 25.21 | 0.28 | 25.49 | 50.99 |
| TAT001_ATO_4891_04000.dat | 0.93 | 25.24 | 0.28 | 25.53 | 51.05 |
| TAT001_ATO_4891_04500.dat | 0.93 | 25.25 | 0.28 | 25.53 | 51.05 |
| TAT001_ATO_4891_05000.dat | 0.93 | 25.25 | 0.28 | 25.53 | 51.06 |
| TAT001_ATO_4891_05500.dat | 0.93 | 25.25 | 0.28 | 25.53 | 51.07 |
| TAT001_ATO_4891_06000.dat | 0.93 | 25.25 | 0.28 | 25.54 | 51.07 |
| TAT001_ATO_4891_06500.dat | 0.93 | 25.25 | 0.28 | 25.53 | 51.07 |
| TAT001_ATO_4891_07000.dat | 0.93 | 25.25 | 0.28 | 25.53 | 51.06 |

It was observed from the results that the dynamic pressure of the flow exerted positive moment of forces on the ball, which would assist the closure of the valve. It is known that for Newtonian fluids, viscosity increases with decreasing temperature, therefore viscous forces would increase for lower temperatures. In the table it can be observed that the moment of forces on the ball valve resulting from the viscous forces is relatively small compared to those from pressure forces. In the CFD analysis a nominal temperature of 50° C. has been used and it should be noted that a decrease in temperature below 50° C. would be expected to slightly increase the magnitude of viscous forces. However, due to the fact that the viscous forces have a lower order of magnitude compared to the pressure forces, the change in temperature would not significantly affect closure time within the operational temperature ranges of the valve.

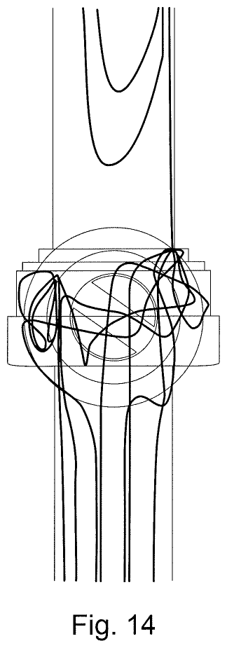

FIG. 14 shows the streamlines of the flow, which demonstrate that the streamlines are regular in the upstream and downstream parts of the geometry and more erratic in the inner part of the ball. The minimum value after convergence of 51.06 Nm was selected as the dynamic fluid force input for the FPA calculations.

### Functional Performance Analysis Results

### Hydraulic Damping and Static Friction Coefficients

The hydraulic damping and the static friction coefficients in the equation of motion (EOM) for the FPA calculations have been estimated from test data. Measurements were available for the frictional forces over the temperature range 0-121° C. at both 0 and 10 ksi. The general trend is that as the temperature increases the frictional force decreases.

### Analysis Results

The FPA results were evaluated by creating and solving the EOM for the ball valve mechanism and deriving the main forces on the piston component. The FPA results are detailed in the table below.

| Flow | | Static | | Time to |
|---|---|---|---|---|
| Case | Flow Rate | Pressure | Temperature* | close |
| ID | [bbl/day] | [ksi] | [° C.] | [s] |
| 1 | Zero | 0 | 50 | 9.37 |
| 2 | Zero | 10 | 50 | 9.46 |
| 3 | 14,000 | 10 | 50 | 9.24 |
| 4 | Zero | 0 | 15 | 10.004 |
| 5 | Zero | 10 | 15 | 11.004 |
| 6 | 14,000 | 10 | 15 | 10.70 |

*The temperature used for the FPA calculations. The frictional damping forces at this temperature have been used.

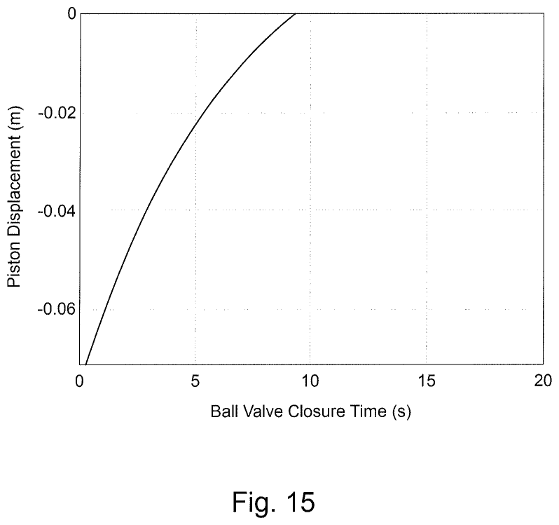

The piston displacement vs. ball valve closure time graphs are documented in FIGS. 15 to 20. The figures provide a representation of the piston displacement (m) vs. ball valve closure time (s) for the ball valve closure of the safe valve under the following conditions:

FIG. 15: Zero Flow, 0 ksi Static Pressure at 50° C. Plot

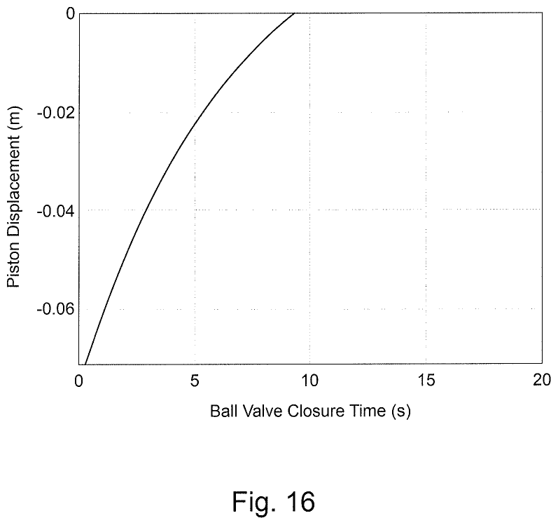

FIG. 16: Zero Flow, 10 ksi Static Pressure at 50° C. Plot

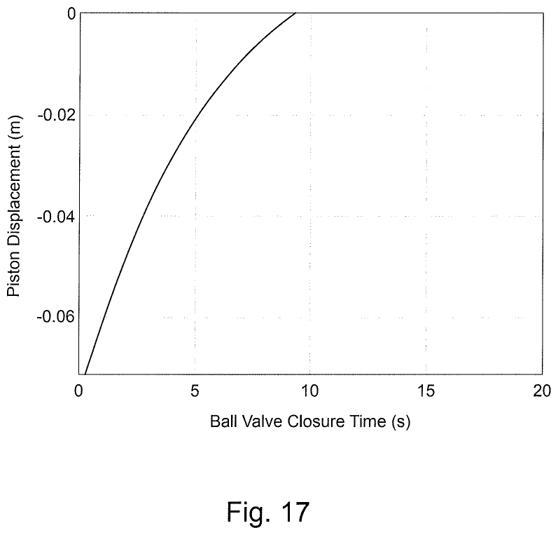

FIG. 17: Flowing, 10 ksi Pressure at 50° C., Dynamic Plot

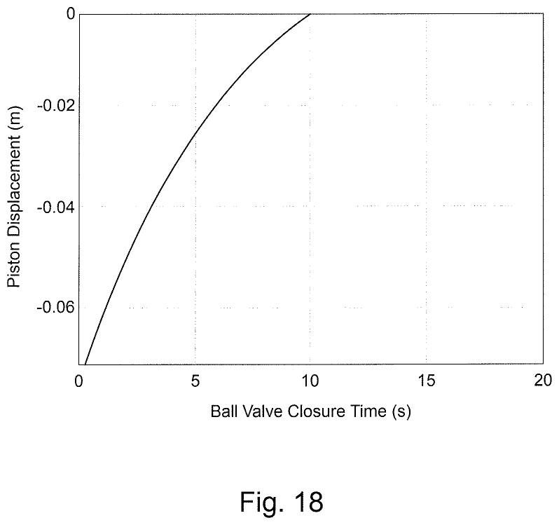

FIG. 18: Zero Flow, 0 ksi Static Pressure at 15° C. Plot

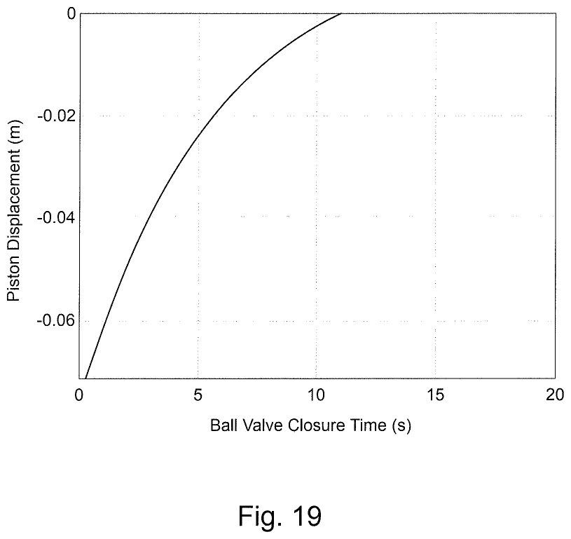

FIG. 19: Zero Flow, 10 ksi Static Pressure at 15° C. Plot

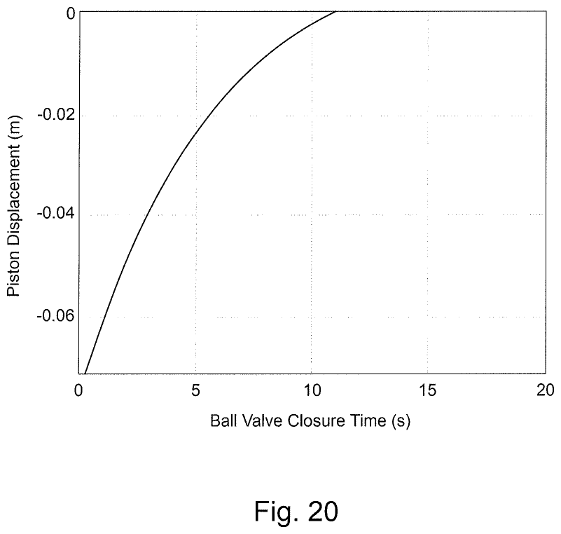

FIG. 20: Flowing, 10 ksi Pressure at 15° C., Dynamic Plot

### Discussion of Results

The CFD analysis calculates the moment of forces induced on the ball at configuration of 80 degrees. This value is used as a maximum moment of force acting over the whole closure cycle. Notably as its direction is shown to aid the valve closure, this estimate for the dynamic fluid force will give a shorter closure time. In the previous table, for cases 3 and 6, the FPA results show that the moment of forces from the CFD analysis aids the closure time compared with the cases 2 and 5 respectively. However the size and direction of the fluid induced force on the ball valve mechanism is such that it only has a marginal effect on the time to closure and that is to reduce it.

For all results in the previous table, the lower temperature of 15° C. results in a higher closure time than comparable cases at 50° C. This is due to an increase in the frictional force at lower temperatures. As the temperature increases above 50° C. the closure time would reduce. It is known that for Newtonian fluids, viscosity increases with decreasing temperature. From results it can be observed that the moment of forces on the ball valve resulting from the viscous forces is very low, therefore it can be concluded that also the temperature effect in this CFD analysis is negligible.

It was found that the spring force and hydraulic damping were the dominant forces in determining the closure time of the safe valve and were several orders of magnitude greater than the moment of fluid force from the CFD analysis.

### Conclusions

The dominant forces were found to be the spring force and the hydraulic damping and these were found to be several orders of magnitude greater than the moment of fluid force.

The moment of force from the CFD for the flowing cases was found to assist the closure time, however it was a relatively small improvement over the respective non-flowing cases.

For the CFD analysis it can be concluded that the effect of temperature on the analysis is negligible as the viscous forces are relatively small in comparison with the pressure forces. For the FPA results a higher closure time was observed at lower temperatures. This is due to an increase in the frictional force at lower temperatures.

The dynamic closure time for the flowing case, 10 ksi pressure is 9.24 seconds at 50° C. and 10.7 seconds at 15° C.

Accordingly, there has been described a computer-implemented method for calculating a valve closure time, the computer-implemented method comprising: performing a computational fluid dynamics (CFD) model simulation of the valve; and performing multiple functional performance analysis (FPA) model simulations of the valve based on said computational fluid dynamics (CFD) model simulation of the valve to calculate the valve closure time.

Accordingly, there has been described a method for calculating a valve closure time includes performing a computational fluid dynamics model simulation of the valve. The method also includes performing multiple functional performance analysis model simulations of the valve based on the computational fluid dynamics model simulation of the valve to calculate the valve closure time. The functional performance analysis model simulations are based on a numerical solution of a second order differential equation according to an equation of motion given by:

[symbol]

ÿ(t)=F_{S}+F_{PPA}+F_{BPA}+F_{g}+F_{μ}+F_{D}+F_{τ}, where m_{L} is a mass of translating components, y(t) is a piston displacement at a given time t, Fτ is a force on the valve due to fluid flow, F_{μ} is a friction force, F_{D} is a hydraulic damping force on the piston, F_{D} is a spring force, FPPA is a hydraulic piston pressure assist force, F_{BPA} is a hydraulic bore pressure assist force, and F_{G} is a force due to gravity.

While this invention has been described above in relation to certain embodiments it will be appreciated that various alternative embodiments can be provided without departing from the scope of the invention which is defined by the appending claims.

1. A computer-implemented method for calculating a valve closure time, the computer-implemented method comprising:
performing a computational fluid dynamics model simulation of the valve; and
performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by: [symbol]
ÿ(t)=F_{S}+F_{PPA}+F_{BPA}+F_{g}+F_{μ}+F_{D}+F_{τ}
where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity.

2. The computer-implemented method according to claim 1, wherein the valve is a ball valve comprising a ball and the computational fluid dynamics model simulation of the valve calculates a magnitude and direction of torque acting on the ball due to fluid flow over the ball.

3. The computer-implemented method according to claim 1, wherein the computational fluid dynamics model simulation of the valve is performed for worst case boundary conditions of a system in which the valve is to be disposed in use.

4. The computer-implemented method according to claim 1, wherein the method further comprises a determination of whether 100% of fluid flow through the valve is stopped within a predetermined time period.

5. The computer-implemented method according to claim 1, wherein the valve forms part of a subsurface test tree.

6. The computer-implemented method according to claim 1, wherein test data at a first pressure and/or flow rate is used as an input to model valve closure time at second pressure and/or flow rate, the first pressure and/or flow rate being lower than the second pressure and/or flow rate.

7. The computer-implemented method according to claim 1, wherein physical test data at zero flow rate is used to extract friction forces and estimate the hydraulic damping coefficient used in the functional performance analysis model simulations of the valve

8. The computer-implemented method according to claim 7, wherein the estimation of the hydraulic damping coefficient comprises:
extracting the friction forces and closure times for zero and maximum pressure at a range of temperatures from test results; and
using an equation of motion to determine the hydraulic damping coefficient that would give an accurate closure time from the test results.

9. The computer-implemented method according to claim 1, wherein a force on the valve calculated using the computational fluid dynamics model and a hydraulic damping force calculated using the functional performance analysis model are input to a further functional performance analysis calculation to determine the valve closure time.

10. The computer-implemented method according to claim 1, wherein the hydraulic piston pressure assist force F_{PPA} and the hydraulic bore pressure assist force F_{BPA} are set to a predetermined value since they assist closure of the valve.

11. A computer readable storage medium comprising computer-executable instructions which, when executed, configure one or more processors to perform a method for calculating a valve closure time, the method comprising:
performing a computational fluid dynamics model simulation of the valve; and
performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by: [symbol]
ÿ(t)=F_{S}+F_{PPA}+F_{BPA}+F_{g}+F_{μ}+F_{D}+F_{τ}
where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity.

12. An electronic device comprising:
an interface device;
one or more processors coupled to the interface device; and
a memory coupled to the one or more processors, the memory having stored thereon computer executable instructions which, when executed, configure the one or more processors to perform
a method for calculating a valve closure time, the method comprising:
performing a computational fluid dynamics model simulation of the valve; and
performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by: [symbol]
ÿ(t)=F_{S}+F_{PPA}+F_{BPA}+F_{g}+F_{μ}+F_{D}+F_{τ}
where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity.

13. A method of designing a valve, the method comprising:
designing a valve configuration;
testing the valve configuration in order to assess the valve's performance by performing a method for calculating a valve closure time, the method comprising:
performing a computational fluid dynamics model simulation of the valve; and
performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by: [symbol]
ÿ(t)=F_{S}+F_{PPA}+F_{BPA}+F_{g}+F_{μ}+F_{D}+F_{τ}
where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity;
modifying the valve configuration; and
re-testing the modified valve configuration in order to assess the modified valve's performance by performing a method for calculating a valve closure time, the method comprising:
performing a computational fluid dynamics model simulation of the valve; and
performing multiple functional performance analysis model simulations of the valve based on said computational fluid dynamics model simulation of the valve to calculate the valve closure time, wherein the functional performance analysis model simulations are based on a numerical solution of a second order differential equation according to an equation of motion given by: [symbol]
ÿ(t)=F_{S}+F_{PPA}+F_{BPA}+F_{g}+F_{μ}+F_{D}+F_{τ}
where m_{L} is a mass of translating components, y(t) is a piston displacement at a given time t, F_{τ} is a force on the valve due to fluid flow, F_{μ} is a friction force, F_{D} is a hydraulic damping force on the piston, F_{D} is a spring force, F_{PPA} is a hydraulic piston pressure assist force, F_{BPA} is a hydraulic bore pressure assist force, and F_{G} is a force due to gravity,
wherein the method steps are re-iterated until a target valve closure time is achieved.

14. The computer readable storage medium according to claim 11, wherein the valve is a ball valve comprising a ball and the computational fluid dynamics model simulation of the valve calculates a magnitude and direction of torque acting on the ball due to fluid flow over the ball.

15. The computer readable storage medium according to claim 11, wherein the computational fluid dynamics model simulation of the valve is performed for worst case boundary conditions of a system in which the valve is to be disposed in use.

16. The computer readable storage medium according to claim 11, wherein the method further comprises a determination of whether 100% of fluid flow through the valve is stopped within a predetermined time period.

17. The computer readable storage medium according to claim 11, wherein the valve forms part of a subsurface test tree.

18. The computer readable storage medium according to claim 11, wherein test data at a first pressure and/or flow rate is used as an input to model valve closure time at second pressure and/or flow rate, the first pressure and/or flow rate being lower than the second pressure and/or flow rate.

19. The computer readable storage medium according to claim 11, wherein physical test data at zero flow rate is used to extract friction forces and estimate the hydraulic damping coefficient used in the functional performance analysis model simulations of the valve

20. The computer readable storage medium according to claim 19, wherein the estimation of the hydraulic damping coefficient comprises:
extracting the friction forces and closure times for zero and maximum pressure at a range of temperatures from test results; and
using an equation of motion to determine the hydraulic damping coefficient that would give an accurate closure time from the test results.

21. The computer readable storage medium according to claim 11, wherein a force on the valve calculated using the computational fluid dynamics model and a hydraulic damping force calculated using the functional performance analysis model are input to a further functional performance analysis calculation to determine the valve closure time.
